(19) United States
(12) Patent Application Publication
(10) Pub. No.: US 2005/0007582 A1
(43) Pub. Date: Jan. 13, 2005

(54) Methods and apparatus for collection of optical reference measurements for monolithic sensors

(75) Inventors: Philippe Villers, Concord, MA (US); Robert K. Rowe, Corrales, NM (US); Kristin A. Nixon, Albuquerque, NM (US); Karen E. Unruh, Albuquerque, NM (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lumidigm, Inc., Albuquerque, NM (US)

(21) Appl. No.: 10/886,941

(22) Filed: Jul. 7, 2004

Related U.S. Application Data
(60) Provisional application No. 60/485,593, filed on Jul. 7, 2003.

(51) Int. Cl. G01N 21/55

(52) U.S. Cl. 356/300

(57) ABSTRACT

Methods and apparatus are provided for collecting optical data. Light is propagated through a reference sample from a source of light to a detector of light to produce a measured reference spectral distribution. Light is also propagated through a subject sample from the source of light to the detector of light to produce a measured subject spectral distribution. At least one of an intensity change and a wavelength shift between the measured reference spectral distribution and a stored reference spectral distribution is identified. The measured subject spectral distribution is compared with a stored subject spectral distribution associated with the stored reference spectral distribution. Such comparison includes accounting for the identified one of the intensity change and the wavelength shift.

### CROSS REFERENCE TO RELATED APPLICATIONS

This application is a nonprovisional of and claims the benefit of the filing date of Provisional Application No. 60/485,593, filed Jul. 7, 2003, which is herein incorporated by reference in its entirety for all purposes.

### BACKGROUND OF THE INVENTION

This application relates generally to optical sensors. More specifically, this application relates to methods and systems for collection of optical reference measurements for spectroscopic optical sensors.

There are a variety of applications in which optical sensors may be used in collecting data from living subjects. In such applications, a spectral distribution of light over some wavelength range is examined and perhaps compared with other spectral distributions. These other spectral distributions may represent data taken from the same subject at a different time or may represent data taken from another subject. Information is typically extracted by identifying similarities or differences between the spectral distributions, which is performed by comparing the spectral distributions. One challenge in performing such comparisons is to identify when differences in the spectral distributions are actually artifacts, resulting from such factors as wavelength shift or a change in intensity of the light source(s), or a change in the responsivity of the detector, or a combination of such effects. The accuracy of the comparison very much depends on an ability to distinguish such artifacts from real, physically based differences in the spectra.

There is, accordingly, a general need in the art for methods and systems that permit compensation for such effects to remove artifact-based differences in spectral distributions.

### BRIEF SUMMARY OF THE INVENTION

Embodiments of the invention provide methods and apparatus for collecting optical data. Light is propagated through a reference sample from a source of light to a detector of light to produce a measured reference spectral distribution. Light is also propagated through a subject sample from the source of light to the detector of light to produce a measured subject spectral distribution. At least one of an intensity change and a wavelength shift between the measured reference spectral distribution and a stored reference spectral distribution is identified. The measured subject spectral distribution and its associated stored reference spectral distribution is compared with a stored subject spectral distribution and its associated stored reference spectral distribution. Such comparison includes accounting for the intensity change and/or the wavelength shift. These methods may be implemented with an optical sensor that comprises the source of light, detector of light, and reference material.

There are a variety of compositions that may be used for the reference material and configurations of the optical sensor that comprises it. For example, in one embodiment, the reference sample comprises a substantially homogeneous material, such as collagen and water. In another embodiment, the reference sample is heterogeneous. Such a heterogeneous reference sample may comprise a plurality of areas of substantially homogeneous material. In a particular embodiment where the source of light comprises one or more sources of light and the detector of light comprises a plurality of detectors of light, each of the areas of substantially homogeneous material may be configured such that different proportions of the homogeneous material are associated with different paths from the sources of light to the detectors of light.

In other embodiments, the reference sample comprises a plurality of reference samples, which have substantially different spectral characteristics. In one such embodiment, the plurality of reference samples comprise a plurality of optical filters. In some embodiments, one of the reference samples has a flat spectral reflection characteristic. In some embodiments, one of the reference samples is optically black or non-reflecting. In further embodiments, the reference sample comprises a spectrally dispersive element. In still other embodiments, the reference sample comprises a filter having a wavelength-dependent profile, which may further have an angular-dependent profile in one embodiment.

The optical sensor may also comprise a device adapted for selective presentation of the reference sample to the source of light and detector of light. Such a device may be further adapted to act as a protective cover for the optical sensor. In some instances, the device may be adapted to dispense discrete units of the reference sample.

In one embodiment, the reference sample comprises a plurality of holes arranged according to a geometrical arrangement of the source of light and the detector of light. In this embodiment, the device may be adapted to move the reference sample to align the plurality of holes with the geometrical arrangement. In another embodiment, the reference sample comprises a material having a first state that is opaque at a wavelength of the source of light and a second state that is transparent at the wavelength of the source of light. In this embodiment, the device may be adapted to change the state of the material. In a further embodiment, the device is adapted to shield the detector of light from some or all wavelengths of ambient light while light is propagated through the subject sample.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a top view of a schematic illustration of the structure of a monolithic optical sensor used in embodiments of the invention;

FIGS. 2A-2C provide exemplary spectral distributions that may be compared in performing functions with the monolithic optical sensor shown in FIG. 1;

FIG. 3 provides a side view of a schematic illustration of a structure for optical reference material used with a monolithic optical sensor in one embodiment of the invention;

FIG. 4 provides a side view of a schematic illustration of a structure for optical reference material used with a monolithic optical sensor in another embodiment of the invention;

FIGS. 5A-5H provide schematic illustrations of combinations of a monolithic optical sensor and reference material used in further embodiments of the invention;

FIGS. 6A and 6B provide side views of schematic illustrations of the use of optically dependent material properties of reference material used with a monolithic optical sensor in another embodiment of the invention;

FIG. 7 provides a side view of a schematic illustration of the use of an optical-shield housing that comprises reference material in a further embodiment of the invention; and

FIGS. 8A and 8B provide side views of schematic illustrations of embodiments in which leakage through a monolithic sensor is used.

### DETAILED DESCRIPTION OF THE INVENTION

1. Introduction

The number of applications in which comparisons of spectral distributions derived from living subjects provide useful information is diverse. For example, in some applications, optical sensors may be used to determine analyte concentrations in individuals as an aid to diagnosing disease such as diabetes. Examples of such applications are described in U.S. Pat. Nos. 5,655,530 and 5,823,951, both of which are incorporated herein by reference in their entireties for all purposes. These applications relate to near-infrared analysis of a tissue analyte concentration that varies with time. Similarly, U.S. Pat. No. 6,152,876, which is also incorporated herein by reference in its entirety for all purposes, discloses improvements in non-invasive living tissue analyte analysis.

U.S. Pat. No. 5,636,633, the entire disclosure of which is incorporated herein by reference, relates in part to another aspect of accurate non-invasive measurement of an analyte concentration. The apparatus described therein includes a device having transparent and reflective quadrants for separating diffuse reflected light from specular reflected light. Incident light projected into the skin results in specular and diffuse reflected light coming back from the skin. Specular reflected light has little or no useful information and is preferably removed prior to collection. U.S. Pat. No. 5,935,062, the entire disclosure of which has been incorporated herein by reference, discloses a further improvement for accurate analyte concentration analysis which includes a blocking blade device for separating diffuse reflected light from specular reflected light. The blade allows light from the deeper, inner dermis layer to be captured, rejecting light from the surface, epidermis layer, where the epidermis layer has much less analyte information than the inner dermis layer, and contributes noise. The blade traps specular reflections as well as diffuse reflections from the epidermis.

In one specific application, optical sensors may be used to monitor blood-alcohol levels in individuals, as described in copending, commonly assigned U.S. Prov. Pat. Appl. No. 60/460,247, entitled “NONINVASIVE ALCOHOL MONITOR,” filed Apr. 4, 2003 by Robert K. Rowe and Robert M. Harbour, the entire disclosure of which is incorporated herein by reference for all purposes.

In other applications, optical sensors may be used in biometric identification or identity-verification applications. Examples of such applications for optical sensors are disclosed in the following copending, commonly assigned applications, the entire disclosure of each of which is incorporated herein by reference for all purposes: U.S. Prov. Pat. Appl. No. 60/403,453, entitled “BIOMETRIC ENROLLMENT SYSTEMS AND METHODS,” filed Aug. 13, 2002 by Robert K. Rowe et al.; U.S. Prov. Pat. Appl. No. 60/403,452, entitled “BIOMETRIC CALIBRATION AND DATA ACQUISITION SYSTEMS AND METHODS,” filed Aug. 13, 2002 by Robert K. Rowe et al.; U.S. Prov. Pat. Appl. No. 60/403,593, entitled “BIOMETRIC SENSORS ON PORTABLE ELECTRONIC DEVICES,” filed Aug. 13, 2002 by Robert K. Rowe et al.; U.S. Prov. Pat. Appl. No. 60/403,461, entitled “ULTRA-HIGH-SECURITY IDENTIFICATION SYSTEMS AND METHODS,” filed Aug. 13, 2002 by Robert K. Rowe et al.; U.S. Prov. Pat. Appl. No. 60/403,449, entitled “MULTIFUNCTION BIOMETRIC DEVICES,” filed Aug. 13, 2002 by Robert K. Rowe et al.; U.S. patent application Ser. No. 09/415,594, entitled “APPARATUS AND METHOD FOR IDENTIFICATION OF INDIVIDUALS BY NEAR-INFRARED SPECTRUM,” filed Oct. 8, 1999 by Robert K. Rowe et al.; U.S. patent application Ser. No. 09/832,534, entitled “APPARATUS AND METHOD OF BIOMETRIC IDENTIFICATION AND VERIFICATION INDIVIDUALS USING OPTICAL SPECTROSCOPY,” filed Apr. 11, 2001 by Robert K. Rowe et al.; U.S. patent application Ser. No. 09/874,740, entitled “APPARATUS AND METHOD OF BIOMETRIC DETERMINATION USING SPECIALIZED OPTICAL SPECTROSCOPY SYSTEM,” filed Jun. 5, 2001 by Robert K. Rowe et al.; and U.S. patent application Ser. No. 10/407,589, entitled “METHODS AND SYSTEMS FOR BIOMETRIC IDENTIFICATION OF INDIVIDUALS USING LINEAR OPTICAL SPECTROSCOPY,” filed Apr. 3, 2003 by Robert K. Rowe et al.

Optical sensors may also be used to make “liveness” determinations by identifying whether specific tissue samples are currently alive, even distinguishing from tissue that was once alive but is no longer. The physiological effects that give rise to spectral features that indicate the liveness state of a sample include, but are not limited to, blood perfusion, temperature, hydration status, glucose and other analyte levels, and overall state of tissue decay.

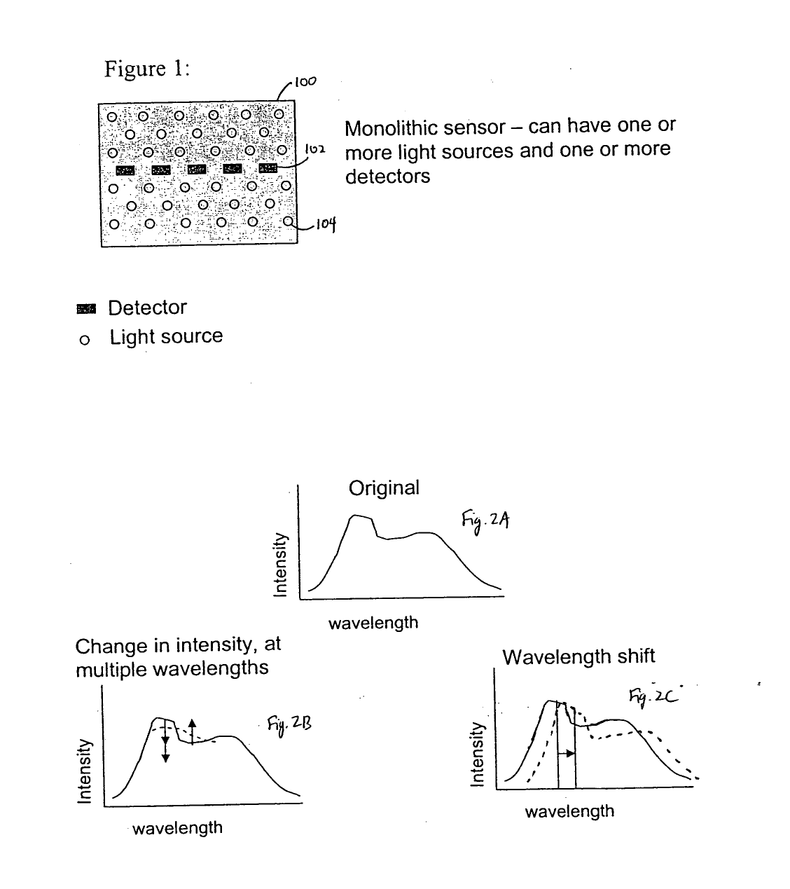

A structure of a typical monolithic sensor that may be used for such varied applications is illustrated schematically in FIG. 1. The monolithic sensor 100 may include one or more light sources 104 and one or more light detectors 102. The light sources 104 could comprise LEDs, laser diodes, VCSELs, or other solid-state optoelectronic devices. The detectors 102 may comprise, for example, Si, PbS, PbSe, InSb, InGaAs, MCT, bolometers and micro-bolometer arrays. The wavelength range of the light sources 104, and the wavelength detection range of the light detectors 102, is usually defined by the specific intended application for the sensor. For example, biometric identifications might use a wavelength range of about 350-1100 nm, alcohol-monitoring applications might use a wavelength range of about 1.5-2.5 μm, analyte-concentration analysis might use a wavelength range that includes identifiable spectral features of the particular analyte, etc. Furthermore, it will be appreciated that the arrangement of light sources 104 and light detectors 102 is intended merely to be illustrative and that many other configurations may be used in various embodiments, also often depending on the specific application intended for the sensor. In some embodiments, only a single light source 104 may be used and, in other embodiments, only a single light detector 102 may be used.

The mechanisms by which spurious differences in spectra may arise when performing spectral comparisons, particularly when the spectra being compared were obtained under different conditions, is illustrated schematically with FIGS. 2A-2C. In FIG. 2A, a reference spectrum taken at a first time is shown schematically as having a wavelength distribution, with certain features in the spectrum being manifested at certain wavelengths. FIG. 2B illustrates a spectrum taken at a second time from the same subject in which a change in intensity of the light source(s) causes an apparent change in spectral strength at various wavelengths. These changes, however, do not correspond to actual physical changes in the subject, but are rather artifacts resulting from differences in measurement conditions. FIG. 2C illustrates a spectrum taken at a third time from the same subject. In this case, the relative spectral strength over the spectrum is substantially identical to that of FIG. 2A, but includes a spectral shift towards higher wavelengths. A comparison of spectral strength at specific wavelengths thus shows apparent differences, but these differences are again artifacts of the different measurement conditions and do not indicate a spectral difference indicative of, say, a change in analyte concentration or of a difference in identity of the subject. In some instances, artifacts may arise from a combination of spurious intensity and wavelength-shift changes.

In some embodiments, the presence of such artifacts is avoided by performing optical background measurements with light that has interacted with a reference sample, thereby providing a standard calibration measure for analysis of spectra obtained from actual subjects. Such embodiments described herein may be used in applications involving sensors for making measurements on biological tissue, such as for making biometric identifications, for analyzing analyte concentrations, making liveness determinations, and the like. Measurements of the spectral distribution of a subject are associated with one or more of the stored reference spectra that represent the spectral qualities of the sensor at the time the subject measurement was made. When a comparison is to be made between two spectra for actual subjects, it includes a comparison of the associated reference spectra. If differences exist between the reference spectra, a correction is made to the comparison of the subject spectra. Such a correction may comprise modifying one or both of the spectra being compared in accordance with differences between the reference spectra before the comparison is made. Alternatively, in some embodiments a post-comparison correction may be made to a resulting difference spectrum or other measure of the similarity of the subject spectra. The embodiments described herein may generally be used in applications when the sensor has one or more light sources and one or more light detectors.

2. Reference Sample Structures

In some embodiments, the reference sample comprises a substantially homogeneous gel that is spectrally similar to a typical living tissue sample. For example, in applications where the living sample comprises human tissue, the homogeneous gel may be configured to have spectral characteristics of a mean human tissue sample. This reference sample thus provides composite information on both light-source changes and wavelength shifts. Because the gel has similar spectral characteristics to the subject(s), there is good reliability in using the information on these changes to compensate for such factors. In one embodiment, the gel comprises a polymeric material. The polymeric material may be chosen so that electromagnetic absorption, reflection, and scattering characteristics are similar to such characteristics in human tissue, at least over the wavelengths used to obtain the spectra. In another embodiment, the gel comprises specific chemical substances found in the relevant human tissue. For example, in the case where the human tissue comprises skin, the gel may comprise collagen, hemoglobin and water.

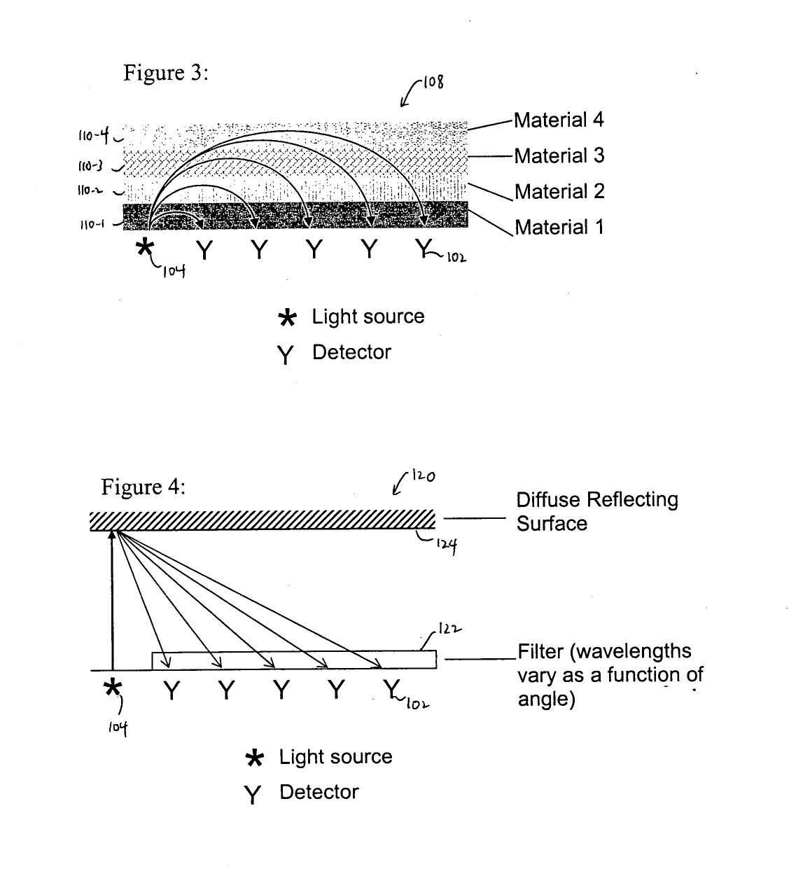

In other embodiments, a plurality of spectrally heterogeneous samples are used to provide information both about light-source intensity changes and about wavelength changes. These embodiments are suitable when used with a sensor 100 that has one or more light sources 104 and a plurality of light detectors 102. In one such embodiment, illustrated in FIG. 3, the spectrally heterogeneous reference sample 108 comprises a plurality of spectrally homogeneous materials 110. Merely by way of example, suitable homogeneous materials include diffuse reflecting materials, gels, pastes, and blasted aluminum.

Merely for illustrative purposes, FIG. 3 shows the spectrally homogeneous materials 110 in a particular geometry, namely with equal-thickness horizontal sheets of material having planes parallel with a plane containing the light detectors 102. It will be appreciated, however, that the invention is not limited to such a geometry and that other geometries may be used in alternative embodiments. For example, the sheets of material could have different thicknesses. The sheets of material could have surface planes parallel with a different plane, such as with a vertical plane orthogonal to the plane containing the light detectors 102, or parallel with a plane inclined at a non-right-angle to the plane containing the light detectors 102. In another embodiment, the sheets of material could have varying thickness so that their surfaces do not define planes at all. To have a spectrally heterogeneous reference sample 108, at least two of the spectrally homogeneous materials 110 have different spectral characteristics, but some or all of the remaining homogeneous materials may have spectral characteristics in common. The different spectrally homogeneous areas 110 may interface directly in some embodiments, although in other embodiments they are separated; such separations may be provided through the use of intermediate optically opaque or optically transparent materials at certain wavelengths.

The exemplary geometrical configuration of homogeneous materials 110 shown in FIG. 3 is an example of a configuration in which the distance between a specific light source 102 and a specific light detector 104 allow light to travel to a separate area of homogeneous material 110. In this way, the resulting spectral-correction information when applied to actual spectral data includes information for specific source-detector combinations.

In a further set of embodiments, multiple reference samples are used. These embodiments may be used in applications involving sensors having one or more light sources and one or more light detectors. The multiple reference samples may all be spectrally homogeneous, may all be spectrally heterogeneous, or may comprise a combination of distinct spectrally homogeneous and spectrally heterogeneous samples. As an example, one of the reference samples may be substantially spectrally flat so that it is sensitive to intensity changes but insensitive to wavelength changes. Another of the reference samples is sensitive both to intensity and wavelength changes. As such, comparisons between spectra that include both intensity and wavelength differences may be performed by using the following correction methodology. Comparisons between the spectrally flat and spectrally nonflat reference samples are used to identify which changes in the spectrally nonflat sample result solely from wavelength changes. The combination of this wavelength-change information and the intensity-change information from the spectrally flat sample is then used to correct the subject-sample comparison for both intensity and wavelength changes. In addition, another of the multiple reference samples might be optically black. The measurements that result from such a reference sample provide further information about effects such as electronic drift and optical light leakage that may be affecting the measurements of actual subjects. This information might be used alone or in conjunction with one or more spectral reflectors to correct the subject-sample comparison.

The correction of spectral analyses may be facilitated in some embodiments by using a plurality of reference samples that are sensitive to both intensity and wavelength changes. This may be particularly useful where the specific characteristics of the intensity- and wavelength-dependent behaviors differ among the reference samples. In particular, such an embodiment permits both intensity and wavelength changes to be assessed by combining information from measurements collected on each of the plurality of samples.

In one such embodiment, multiple samples that comprise layers of optical filters are used. For example, in one set of filters, the filter closest to the sensor is broadest, allowing most of the relevant wavelengths to pass through. Each subsequent layer, as distance from the sensor increases, is increasingly restrictive, allowing a progressively smaller subset of the relevant wavelengths to pass through. The filter closest to the sensor thus corresponds to the spectrally flat sample, with the remaining samples corresponding to samples sensitive to both intensity and wavelength changes, and having different such characteristics. In another example, the passband or transmission edge of the filters is progressively shifted relative to the others for each filter in the stack.

In still a further set of embodiments, the reference sample comprises a spectrally dispersive optical element, such as grating, prism, grism, or other spectrally dispersive element. The optical character of the dispersive element thus simultaneously provides information about light-source intensity and about wavelength changes, effectively providing information similar to that provided by a grating spectrometer. These embodiments may be used in applications involving sensors having one or more light sources and having a plurality of light detectors.

In one specific embodiment, the dispersive element is combined with a monolithic sensor that includes one or more light sources and a plurality of light detectors. Illumination of one of the light sources onto the dispersive element acts to provide angular separation of the component wavelengths. Reflected light collected by the detectors then gives information both on the wavelengths of the light reflected and on the intensity of the light at each such wavelength.

In a further set of embodiments, the reference sample comprises a wavelength-dependent filter, which is used to provide information about both light-source intensity and about wavelength changes. Such embodiments are suitable for applications in which the sensor comprises one or more light sources and a plurality of light detectors. One such embodiment is illustrated in FIG. 4 where the wavelength-dependent filter also comprises an angular-dependent profile to allow tracking of light intensity at specific wavelengths. In particular, in this embodiment the reference sample 120 includes one or more light sources 104 and a plurality of light detectors 102. Light from the light source(s) 104 is reflected from a diffuse reflecting surface 124, which may have a surface plane parallel to a plane containing the plurality of light detectors 102. The wavelength-dependent filter 122 is disposed so that it is encountered by light from the light source(s) 104 reflected from the reflecting surface 124. The geometrical arrangement causes light received by different light detectors 102 to be incident on the wavelength-dependent filter 122 at different angles. The combination of wavelength- and angular-dependent profiles of the filter 122 thus permit the light intensity to be tracked for changes at specific wavelengths. In another embodiment, the filter may be a linear variable filter or other similar filter where the wavelength characteristics vary by position. In different embodiments, the filter may comprise a quarter-wave variable filter, an edge filter, a bandpass filter, a band-reject filter, etc.

3. Reference-Sample Interfaces

There are a variety of ways in which the reference samples described above may be interfaced with a sensor in different embodiments as data are collected. For example, in one set of embodiments, an external user-controlled device is used to collect periodic reference measurements. The external device may be structured such that it comprises a reference sample, such as described above, disposed to be substantially adjacent to the sensor when presented to the sensor. The external device may have supplementary functionality in some embodiments, permitting it to be used as a cover or cap secured to the sensor when the sensor is not in use, but this is not required. In other embodiments, the external device is used exclusively for the collection of reference measurements and is presented by the user only when a reference measurement is to be collected.

In other embodiments, an external user-controlled device may instead have a structure that permits dispensing a reference sample, such as described above, onto the sensor. Such a configuration has the advantage that the user-controlled device may be designed to be disposable. In some embodiments, the reference samples comprised by the external device may be discrete reference samples, such as in the form of wafers, membranes, or thin films that are dispensed from the device onto the sensor by the user. In other embodiments, the reference samples are comprised by a volume of dispensable reference material, such as a gel or paste that the user spreads onto the sensor with the external device.

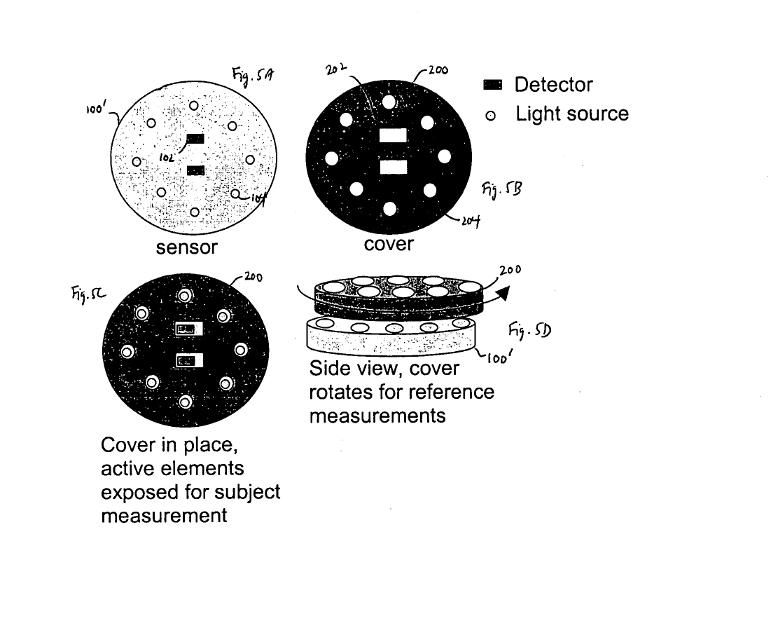

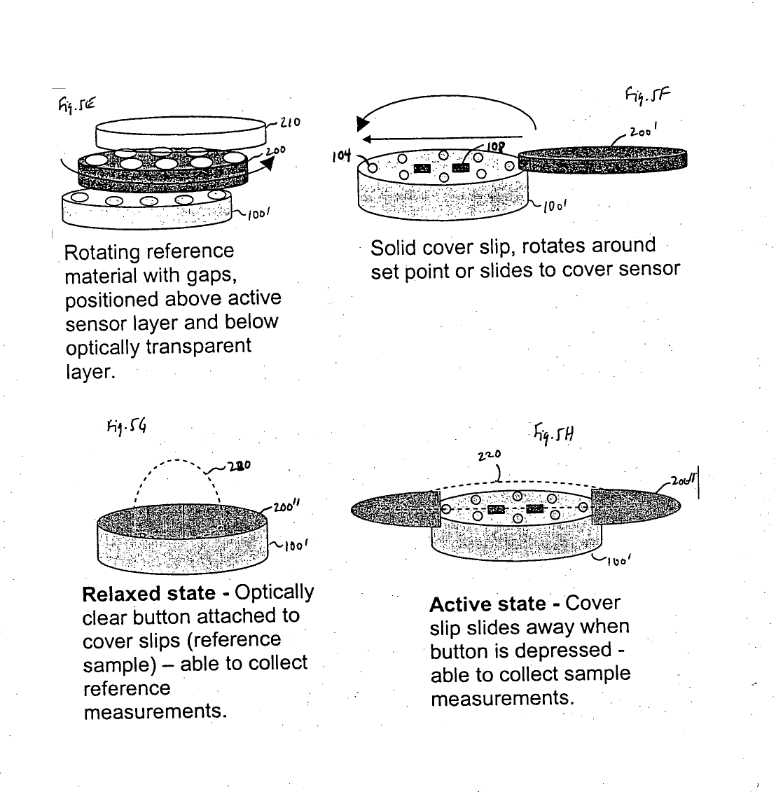

Specific examples of external devices and how they may be used with monolithic optical sensors are illustrated for some embodiments in FIGS. 5A-5H. FIG. 5A provides a top view of a sensor 100′ having a somewhat different geometrical configuration from the sensor shown in FIG. 1A. In this example, the sensor 100′ has a circular shape and includes a plurality of detectors 102 in the center of the sensor 100′ surrounded by a plurality of sources 104. For convenience of illustration, the sources 104 and detectors 102 are shown having different shapes, although this is not required. FIG. 5B shows a top view of an exemplary structure for a cover 200 that comprises the reference material. While in some embodiments, the cover 200 could be a solid piece of material, the structure shown in FIG. 5B advantageously includes a plurality of holes corresponding in size and relative distribution to the sources 104 and detectors 102 of the sensor 100′. This arrangement permits the cover 200 to be used both when reference measurements are taken and when subject measurements are taken. For example, FIG. 5C shows a top view of the cover 200 disposed over the sensor 100′ with the holes in the cover 200 aligned with the sources 104 and detectors 102. Such a configuration is suitable for taking subject measurements since the reference material is not disposed so as to interfere with the measurements. The cover may be rotated or slid, as illustrated with the side view of FIG. 5D, so that all of the sources 104 and detectors 102 are covered by the reference material, making a suitable configuration for taking reference measurements.

In some embodiments, as illustrated with the side view in FIG. 5E, an optically transparent layer 210 may also be provided so that the reference material is disposed between the sensor 100′ and the optically transparent layer 210. The reference material may thus be protected with the optically transparent layer 210. In some embodiments, the optically transparent layer 210 is comprised of optical fibers or is a fiber optic face plate, which acts to channel the light through the transparent portion while minimizing spatial spreading.

FIG. 5F provides a side view of an example of a configuration in which the reference material 200′ is provided as a solid piece, in which case it may be slid onto the sensor 100′ to cover the sources 104 and detectors 102 when a reference measurement is to be taken, and may be slid off the sensor 100′ to expose the sources and detectors 102 when a subject measurement is to be taken.

FIGS. 5G and 5H together illustrate a further configuration in which the state of the reference material 200″ may be controlled with an optically transparent button 220 or activation switch disposed over the sensor 100′ and reference material 200″. Both FIGS. 5G and 5H show side views, with FIG. 5G showing the relaxed state of the device and FIG. 5H showing the active state of the device. In the relaxed state, the optically transparent button 220 is attached over the reference-material cover 200″. This permits reference measurements to be taken since both the sources 104 and detectors 102 are covered by the reference material 200″. The reference-material 200″ cover is provided in a plurality of pieces that separate upon activation of the button 220 to produce the configuration shown in FIG. 5H. In this active state, the sources 104 and detectors 102 are exposed so that subject measurements may be taken. In different embodiments, the button 220 may be activated by different mechanisms, such as by application of pressure, by exposure to light, electrically, and the like.

The examples shown in FIGS. 5A-5H illustrate configurations in which the reference-material cover is at the surface of the sensor 100′ or above a surface of the sensor 100′. In other embodiments, the reference material could instead be disposed below a surface of the sensor 100′, but above the light sources 104 and detectors 102 as part of an integrated device.

In still other embodiments, as illustrated in FIGS. 6A-6B, the reference material may be attached to the sensor and activated by user contact as a result of special material properties. For example, FIGS. 6A and 6B proved side views respectively of a relaxed state and an active state for an embodiment that uses material having such spectral properties. The sensor 100″ includes one or more light sources 104 and a plurality of light detectors 102, with the reference material 230 comprising a bubble disposed over the sensor 100″. In its relaxed state, as shown in FIG. 6A, the material is opaque at the relevant wavelengths so that reference measurements may be taken. When in an active state, such as when compressed as a result of pressure applied by a user, the material may become optically transparent at the relevant wavelengths. This is illustrated in FIG. 6B, where the sensor 100″ is in a configuration that permits taking subject measurements from tissue 234 of a subject.

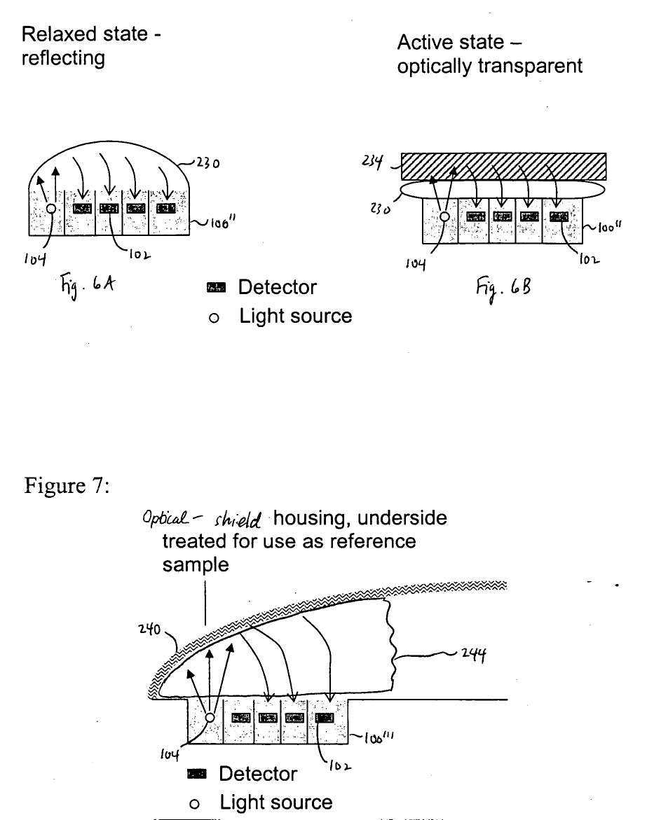

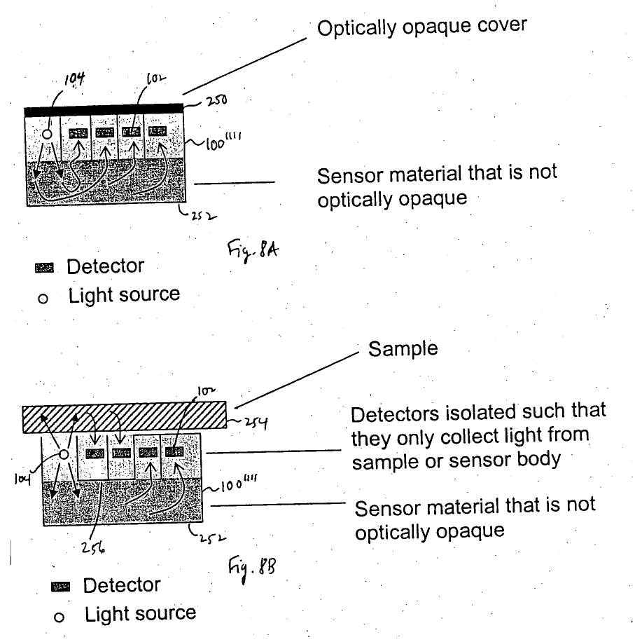

FIG. 7 provides a side-view illustration of still a further embodiment that uses an external device that serves as a dual-purpose housing. The external device 240 comprises reference material such as described above and adapted so that it may be disposed over tissue 244 that is being tested as part of a subject test or is seen directly by the sensor 100′″ when a reference measurement is taken. As before, the sensor 100′″ comprises one or more light sources 104 and a plurality of light detectors 102. In addition to the reference material, which may be included on an underside of the external device 240, the external device 240 may comprise a shielding material on its surface. FIG. 7 shows the external device 240 when disposed over tissue 244, such as over a finger of an individual, in which case the external device 240 may act as a light shield to block ambient light that might otherwise interfere with optical measurements. As another embodiment, the external device 240 might be partially transparent, blocking longer wavelengths that pass easily through a finger while allowing shorter wavelengths to penetrate.

Any of the reference materials described above may be incorporated on the underside of the external device 240 to allow it to be used for reference measurements. For example, the external device 240 could be optically opaque with a diffuse reflector on its underside. Alternatively, the external device 240 could be optically opaque with a dispersive element such as a reflective diffraction grating built into its underside. In another embodiment, the external device 240 could include a filter in a layer on its underside.

A further embodiment is illustrated in FIGS. 8A and 8B in which material properties of the sensor are used to allow light-leakage paths. As shown with the side view of FIG. 8A, in this embodiment, the sensor 100″″ is constructed with one or more light sources 104 and a plurality of light detectors 102 on material 252 that is not optically opaque at the relevant wavelengths, such as on a white ceramic substrate. This allows light leakage paths within the body of the sensor 100″″, which could additionally incorporate optical filters in the leakage paths to separate wavelength shifts from intensity changes. An optically opaque cover 250 over the sensor 100″″ serves to isolate the light leakages. With the cover 250 in place and the light source(s) 104 illuminated, only the light traveling through the body of the sensor 100″″ is detected by the detectors 102. This detected light may thus be used in embodiments of the invention to track intensity and wavelength changes.

When the cover 250 is removed and replaced with a sample to test a subject, the light from the source 104 may travel through the sample to the detectors 102. This may be accompanied by some light leakage along the same paths followed when the cover 250 was in place. In instances where this light leakage is relatively small in comparison to the sample collection mode, the effect of the light leakage is negligible. In instances where the light leakage is relatively large in comparison to the sample collection mode, optical, electro-optical, mechanical, or other shutters may be incorporated into the leakage path to prevent leakage during the sample collection mode.

In some instances, as illustrated with the side view of FIG. 8B, some of the detectors may be isolated within the structure 256. Thus, when subject measurements are taken from a sample 254, light from the source 104 may be directed through the sample 254 to a first subset of the detectors 102 that only receive light scattered from the sample. In addition, a second subset of the detectors 102 may receive light only through the leakage paths. This arrangement thus offers further capabilities for determining intensity and wavelength shifts in the manner described above.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method for collecting optical data, the method comprising:
propagating light from a source of light to a detector of light to produce a measured reference spectral distribution by interaction of the light with a reference sample;
propagating light from the source of light to the detector of light to produce a measured subject spectral distribution by interaction of the light with a subject sample;
identifying at least one of an intensity change and a wavelength shift between the measured reference spectral distribution and a stored reference spectral distribution; and
comparing the measured subject spectral distribution and its associated stored reference spectral distribution with a stored subject spectral distribution and its associated stored reference spectral distribution, wherein such comparing includes accounting for the identified one of the intensity change and the wavelength shift.

2-4. (Canceled).

5. The method recited in claim 1 wherein the reference sample comprises a plurality of areas of substantially homogeneous material.

6. The method recited in claim 5 wherein:
the source of light comprises one or more sources of light;
the detector of light comprises a plurality of detectors of light; and
each of the areas of substantially homogeneous material is associated with a path from one of the one or more sources of light to one of the plurality of detectors of light.

7-11. (Canceled).

12. The method recited in claim 1 further comprising selectively presenting the reference sample to be encountered by an optical path from the source of light to the detector of light.

13. The method recited in claim 12 wherein selectively presenting the reference sample comprises dispensing a discrete unit of the reference sample from a device.

14. The method recited in claim 12 wherein:
the reference sample comprises a solid piece; and
selectively presenting the reference sample comprises moving the reference sample.

15. The method recited in claim 12 wherein:
the reference sample comprises a plurality of holes arranged according to a geometrical arrangement of the source of light and the detector of light; and
selectively presenting the reference sample comprises moving the reference sample to align the plurality of holes with the geometrical arrangement.

16. The method recited in claim 12 wherein:
the reference sample comprises a material having a first state that is opaque at a wavelength of the source of light and a second state that is transparent at the wavelength of the source of light; and
selectively presenting the reference sample comprises changing the state of the material.

17. The method recited in claim 12 further comprising shielding the detector of light from ambient light with the reference sample while propagating light through the subject sample.

18. An optical sensor comprising:
a source of light;
a detector of light; and
a reference sample disposed to encounter light along optical paths from the source to the detector, wherein the reference sample is composed to permit determination of composite information on intensity changes and wavelength shifts of the source of light from a plurality of distinct optical measurements using the optical sensor.

19.-22. (Canceled).

23. The optical sensor recited in claim 18 wherein:
the source of light comprises one or more sources of light;
the detector of light comprises a plurality of detectors of light; and
each of the areas of substantially homogeneous material is associated with a path from one of the one or more sources of light to one of the plurality of detectors of light.

24. The optical sensor recited in claim 18 wherein the reference sample comprises a plurality of reference samples, at least one of which is substantially spectrally flat.

25. (Canceled).

26. The optical sensor recited in claim 18 wherein the reference sample comprises a spectrally dispersive element.

27.-28. (Canceled)

29. The optical sensor recited in claim 18 further comprising a device adapted for selective presentation of the reference sample to the source of light and detector of light.

30. The optical sensor recited in claim 29 wherein the device is further adapted to act as a protective cover for the optical sensor.

31. The optical sensor recited in claim 29 wherein the device is adapted to dispense discrete units of the reference sample.

32. The optical sensor recited in claim 29 wherein:
the reference sample comprises a plurality of holes arranged according to a geometrical arrangement of the source of light and the detector of light; and
the device is adapted to move the reference sample to align the plurality of holes with the geometrical arrangement.

33. The optical sensor recited in claim 29 wherein:
the reference sample comprises a material having a first state that is opaque at a wavelength of the source of light and a second state that is transparent at the wavelength of the source of light; and
the device is adapted to change the state of the material.

34. The optical sensor recited in claim 29 wherein the device is adapted to shield the detector of light from ambient light with the reference sample while light is propagated through a subject sample.

35. The optical sensor recited in claim 18 further comprising a substrate over which the source of light and the detector of light are disposed, wherein the substrate permits light-leakage paths from the source of light to the detector of light.
